(19) United States
(12) Patent Application Publication
(10) Pub. No.: US 2026/0288553 A1
(43) Pub. Date: Sep. 24, 2026

(54) MANAGING DEVICE HEALTH USING A MANAGEMENT CONTROLLER OF A DATA PROCESSING SYSTEM

(71) Applicant: Dell Products L.P., Round Rock, TX (US)

(72) Inventors: XIAOMEI ZHU MILLER, Round Rock, TX (US); ADOLFO SANDOR MONTERO, Pflugerville, TX (US); PHANINDRA BHARGAV TALASILA, Georgetown, TX (US); IBRAHIM SAYYED, Georgetown, TX (US)

(21) Appl. No.: 19/085,612

(22) Filed: Mar. 20, 2025

(51) Int. Cl. G06F 11/00

(52) U.S. Cl. CPC G06F 11/004; G06F 2201/81

(57) ABSTRACT

Methods and systems for managing operations of a data processing system are disclosed. To manage operations of the data processing system, a management controller of the data processing system may obtain diagnostic data from a storage device of hardware resources of the data processing system. The management controller may initiate performance of a health analysis process to determine a level of health for the storage device. If the level of health meets criteria, the management controller may obtain an action set for updating operation of the data processing system. The management controller may perform the action set to reduce a level of impact of undesired operation of the storage device on provisioning of computer-implemented services by the data processing system.

### FIELD

Embodiments disclosed herein relate generally to managing operation of a data processing system. More particularly, embodiments disclosed herein relate to systems and methods to manage device health using a management controller of a data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show block diagrams illustrating a system in accordance with an embodiment.

FIGS. 2A-2B show interaction diagrams in accordance with an embodiment.

FIG. 3 shows a flow diagram illustrating a method of managing a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may include hardware resources (e.g., such as hardware components) and/or software components that, in some combination, may be used to provide computer-implemented services. To provide the computer-implemented services, the hardware resources may perform tasks while the data processing system is in a desired operating state.

For example, the hardware resources of the data processing system may include a storage device (e.g., a non-volatile memory express (NVMe) solid-state drive). The storage device may be used to redundantly store a copy of boot data (e.g., basic input/output system (BIOS) firmware, system configuration files, etc.), which may be used by a processor of the hardware resources (e.g., a central processing unit (CPU)) to perform a booting process for the data processing system. The booting process may allow: (i) functionality of a portion of the hardware resources and/or software components to be enabled, and/or (ii) an operating system of the data processing system to be booted. Doing so may allow the data processing system to be placed in the desired operating state to facilitate provisioning of the computer-implemented services.

However, operation of and/or computer-implemented services provided by the data processing system may be negatively impacted if any of the hardware resources suffer from undesired operation. For example, the storage device may suffer from undesired operation due to physical wear during normal operation over time, power issues (e.g., power surges, insufficient power supply), over-heating, compromise (e.g., installation of malware by a malicious entity), etc.

If the storage device suffers from the undesired operation, for example, the boot data stored on the storage device may be unable to be used by the processor during the booting process. As a result, the operating system of the data processing system may be unable to be booted, and the data processing system may be unable to be placed in the desired operating state to provide the computer-implemented services.

To improve a likelihood that the data processing system is placed in the desired operating state, the processor may collect diagnostic data from the hardware resources (e.g., telemetry data, health data, self-monitoring, analysis and reporting technology (SMART) data) via in-band communication channels while the operating system is booted. The diagnostic data may be usable to monitor the hardware resources for indications of divergence from desired operation. Using the diagnostic data, actions may be performed by the operating system to reduce a likelihood of hardware component failure, mitigate an impact of hardware component failure, etc.

However, if the operating system is not booted (e.g., due to the hardware resources being powered off), the operating system is unable to be booted (e.g., due to undesired operation of the storage device), and/or the processor lacks necessary software, the diagnostic data may be unable to be obtained by the processor. As a result, a portion of the hardware resources may suffer from the undesired operation.

To reduce an impact of the undesired operation on provisioning of the computer-implemented services, the data processing system may include out-of-band components, such as a management controller. The management controller may be distinct from and adapted to manage the hardware resources. As a result, the management controller may obtain the diagnostic data, even in instances when the in-band methods are unavailable (e.g., the operating system is not booted and/or the processor is otherwise unable to obtain the diagnostic data).

Using the diagnostic data, the management controller may initiate performance of a health analysis process to determine a level of health for the storage device. For example, initiating performance of the health analysis process may include providing the diagnostic data by the management controller to a remote system via an out-of-band communication channel. In response to providing the diagnostic data, the management controller may receive an indication regarding whether the level of health meets criteria. The criteria may include a threshold level of health for the storage device, and meeting the threshold level of health may indicate that the storage device has an unacceptable risk of suffering from the undesired operation. If the level of health meets the criteria, the management controller may obtain and perform an action set for updating operation of the data processing system.

Thus, embodiments disclosed herein may address, among other technical problems, the technical challenge of reducing a level of impact of undesired operation of hardware resources of a data processing system on provisioning of computer-implemented services by the data processing system. By using out-of-band components such as a management controller, a likelihood that health management services for the hardware resources may be provided as desired may be improved. As a result, the computer-implemented services may be provided to downstream consumers of the services as desired.

In an embodiment, a method for managing operation of a data processing system is disclosed. The method may include: obtaining, by a management controller of the data processing system and from a storage device of hardware resources of the data processing system, diagnostic data, the diagnostic data being generated by the storage device based on operation of the storage device; initiating, by the management controller and using the diagnostic data, performance of a health analysis process to determine a level of health for the storage device; in an instance of the initiating in which the level of health meets criteria: obtaining, by the management controller, an action set for updating operation of the data processing system; and performing, by the management controller, the action set to reduce a level of impact of undesired operation of the storage device on provisioning of computer-implemented services by the data processing system.

Initiating performance of the health analysis process may include: providing, by the management controller and via an out-of-band communication channel, the diagnostic data to a remote system; and receiving, by the management controller and via the out-of-band communication channel, an indication regarding whether the level of health meets the criteria in response to the providing.

Obtaining the diagnostic data may include: selectively powering the storage device by the management controller while other hardware resources of the hardware resources of the data processing system remain unpowered.

The diagnostic data may be obtained by the management controller when an operating system of the data processing system is unable to be booted.

A processor of the hardware resources of the data processing system may be adapted to obtain the diagnostic data from the storage device via an in-band channel of the data processing system when the operating system is booted, and the management controller may be adapted to obtain the diagnostic data from the storage device via a side band channel when the operating system is unable to be booted.

Boot data usable to boot the operating system may be redundantly stored on, at least, the storage device, and the operating system may be unable to be booted due to the processor being unable to obtain the boot data from, at least, the storage device.

The criteria may include a threshold level of health for the storage device, and meeting the threshold level of health may indicate that the storage device has an unacceptable risk of suffering from the undesired operation.

The action set may include at least one action selected from a list of actions consisting of: notifying a user of the data processing system to the level of health for the storage device; modifying use of the storage device; moving data stored on the storage device to a second storage device of the data processing system; and providing a copy of the data stored on the storage device to a remote system.

The diagnostic data may be self-monitoring, analysis and reporting technology (SMART) data.

The management controller may operate independently from and may be distinct from the hardware resources.

The diagnostic data may be obtained by the management controller via a side band channel of the data processing system.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

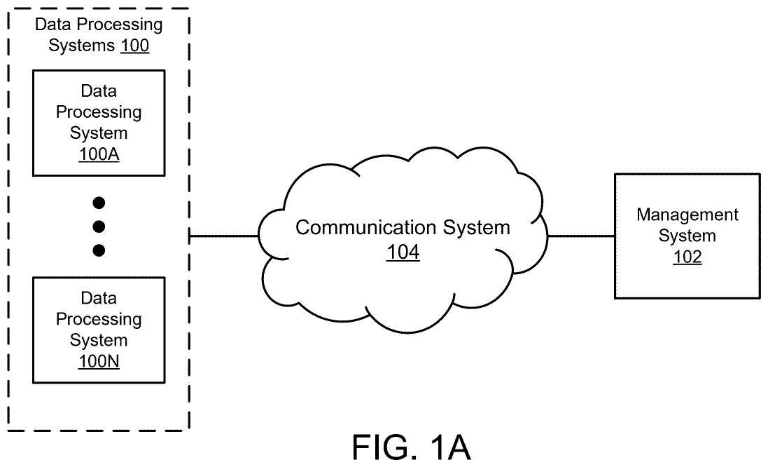

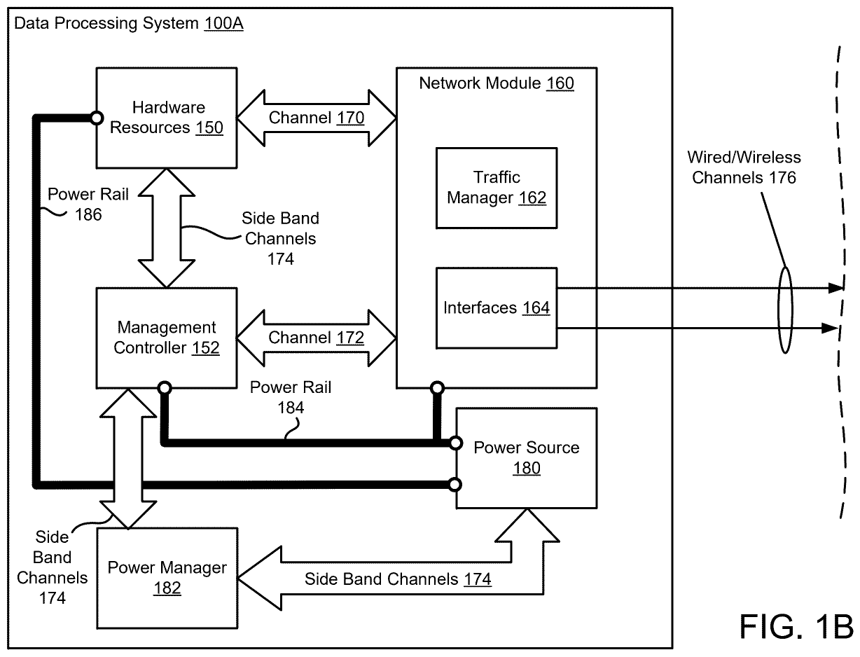

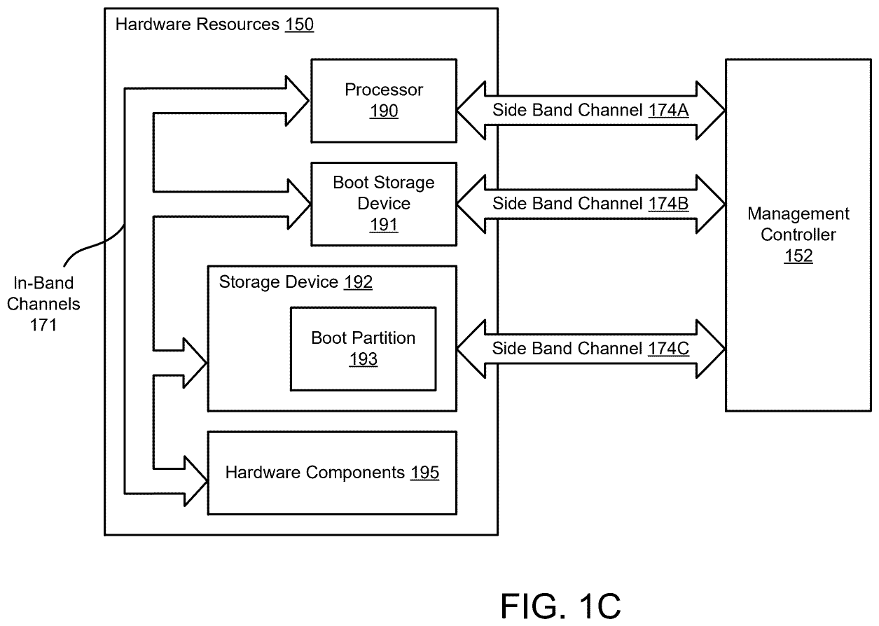

Turning to FIG. 1A, a block diagram illustrating a system in accordance with an embodiment is shown. The system shown in FIG. 1A may provide for management of any number of data processing systems (e.g., 100A-100N) that may provide, at least in part, computer-implemented services (e.g., to users of the system and/or devices operably connected to the system). The computer-implemented services may include any type and quantity of services including, for example, data services (e.g., data storage, access, and/or control services), communication services (e.g., instant messaging services, video-conferencing services), and/or any other type of service that may be implemented with a computing device. Other types of computer-implemented services may be provided by the system shown in FIG. 1A without departing from embodiments disclosed herein.

To provide the computer-implemented services, each data processing system may include hardware resources including hardware components (e.g., processors, memory modules, storage devices, communication devices, etc.). The hardware components may support execution of any number and type of applications (e.g., software components). Changes in available functionalities of the hardware and/or software components may provide for various types of different computer-implemented services to be provided over time. Refer to FIG. 1B-1C for additional details regarding data processing systems 100.

In order to provide the computer-implemented services, the hardware components of a data processing system (e.g., 100A) may perform tasks while in the data processing system is in a desired operating state. For example, data processing system 100A may include a storage device (e.g., a non-volatile memory express (NVMe) solid-state drive) used to redundantly store boot data (e.g., basic input/output system (BIOS) firmware, system configuration files, etc.). A processor (e.g., a central processing unit (CPU)) of the hardware components may utilize the boot data stored on the storage device during a booting process (e.g., a startup) for data processing system 100A to initialize operation of the hardware components. By performing the booting process, the hardware components of data processing system 100A may be operably connected to each other (e.g., via in-band channels) and an operating system (and/or other management entity) may be booted to provide management functionality. In doing so, data processing system 100A may be placed in the desired operating state to provide the computer-implemented services.

However, operation of and/or computer-implemented services provided by data processing system 100A may be negatively impacted if any of the hardware components suffer from undesired operation. For example, the storage device may suffer from undesired operation due to physical wear during normal operation over time, power issues (e.g., power surges, insufficient power supply), over-heating, compromise (e.g., installation of malware by a malicious entity), etc.

If the storage device suffers from the undesired operation, for example, the boot data stored on the storage device may be unable to be used by the processor during the booting process. Consequently, data processing system 100A may be unable to be placed in the desired operating state to provide the computer-implemented services. As a result, the computer-implemented services may be interrupted, delayed, and/or of a reduced quality.

To reduce a risk of the hardware components suffering from the undesired operation, the processor may collect diagnostic data from the hardware components (e.g., telemetry data, health data, self-monitoring, analysis and reporting technology (SMART) data) via in-band communication channels while the operating system is booted. The diagnostic data may be usable to monitor the hardware components for indications of divergence from desired operation. Based on the diagnostic data, actions may be performed by the processor to reduce a likelihood of hardware component failure, mitigate an impact of hardware component failure, etc.

However, the processor may be unable to collect the data from the hardware components. For example, the processor may be unable to collect the data due to: (i) the hardware resources being unpowered, (ii) the operating system being unable to be booted (e.g., due to undesired operation of the storage device and/or other hardware components needed to boot the operating system), and/or (iii) the processor lacking software to collect data from certain hardware components. As a result of the operating system being unable to collect the data, a portion of the hardware components may suffer from the undesired operation, which may impact operation of and/or computer-implemented services provided by data processing system 100A.

In general, embodiments disclosed herein may provide methods, systems, and/or devices for managing operation of a data processing system in a manner that reduces an impact of undesired operation of hardware resources of the data processing system on provisioning of computer-implemented services. To do so, the data processing system may include out-of-band resources such as a management controller. The management controller may be distinct from and adapted to manage the hardware resources of the data processing system. For example, the management controller may provide health management services for the hardware resources. By providing the health management services using out-of-band methods, the health management services may continue to be provided in instances when in-band methods are unavailable, such as when the operating system is unable to be booted, the hardware resources are unpowered, etc. As a result, a likelihood of undesired operation of the hardware resources impacting provisioning of computer-implemented services by the data processing system may be reduced.

To provide the health management services, the management controller may obtain diagnostic data from a hardware component of the hardware resources (e.g., a storage device) via a side band channel of the data processing system. The diagnostic data may be generated by the storage device based on operation of the storage device, and may include self-monitoring, analysis and reporting technology (SMART) data (e.g., seek time performance, power-on hours, uncorrectable error count, etc.).

Using the diagnostic data, the management controller may initiate performance of a health analysis process to determine a level of health for the storage device. For example, initiating performance of the health analysis process may include providing the diagnostic data by the management controller to a remote system via an out-of-band communication channel. In response to providing the diagnostic data, the management controller may receive an indication regarding whether the level of health meets criteria. The criteria may include a threshold level of health for the storage device, and meeting the threshold level of health may indicate that the storage device has an unacceptable risk of suffering from the undesired operation.

If the level of health meets the criteria, the management controller may obtain and perform an action set for updating operation of the data processing system. The action set may include actions such as notifying a user of the data processing system to the level of health, modifying use of the storage device, moving data stored on the storage device to a different storage device of the data processing system, etc. As a result, the level of impact of the undesired operation on provisioning of the computer-implemented services may be reduced, and the computer-implemented services may be provided to downstream consumers of the services as desired.

To perform the above-mentioned functionality, the system of FIG. 1A may include data processing systems 100, and/or management system 102. Data processing systems 100, management system 102, any components thereof and/or any other types of devices or components not shown in FIG. 1A may perform all, or a portion of the computer-implemented services independently and/or cooperatively. Each of these components is discussed below.

Data processing systems 100 may include any number and type of data processing systems (e.g., 100A-100N) that may individually and/or cooperatively provide at least a portion of the computer-implemented services. Any of data processing systems 100 may include in-band components (e.g., hardware resources), out-of-band components (e.g., a management controller), and functionality that may allow the out-of-band components to communicate with management system 102 via an out-of-band communication channel.

While providing the at least the portion of the computer-implemented services, a data processing system (e.g., 100A) of data processing systems 100 may transmit and/or receive information from management system 102 (e.g., a remote system). For example, a management controller of data processing system 100A may communicate with management system 102 via an out-of-band communication channel. Using the out-of-band communication channel, the management controller may provide and obtain the information from management system 102 without traversing potentially compromised in-band communication channels. Doing so may reduce a risk of the information being obtained by a malicious and/or unauthorized entity, being unable to be obtained by data processing system 100A (e.g., due to the in-band components being powered off and/or otherwise inoperable), etc.

For example, the information provided by the management controller of data processing system 100A to management system 102 may include diagnostic data, including SMART data, telemetry data, health data, and/or other types of data usable to determine levels of health for hardware resources of data processing system 100A. In response to the management controller providing the diagnostic data, management system 102 may provide: (i) the levels of health, (ii) indications regarding whether the levels of health meet criteria, (iii) instructions for updating operation of data processing system 100A (e.g., based on the levels of health), (iv) management requests to modify operation of the hardware resources (e.g., installing new applications), (v) and/or any other information. The management controller of data processing system 100A may subsequently perform actions based on the information obtained from management system 102 to update operation of data processing system 100A.

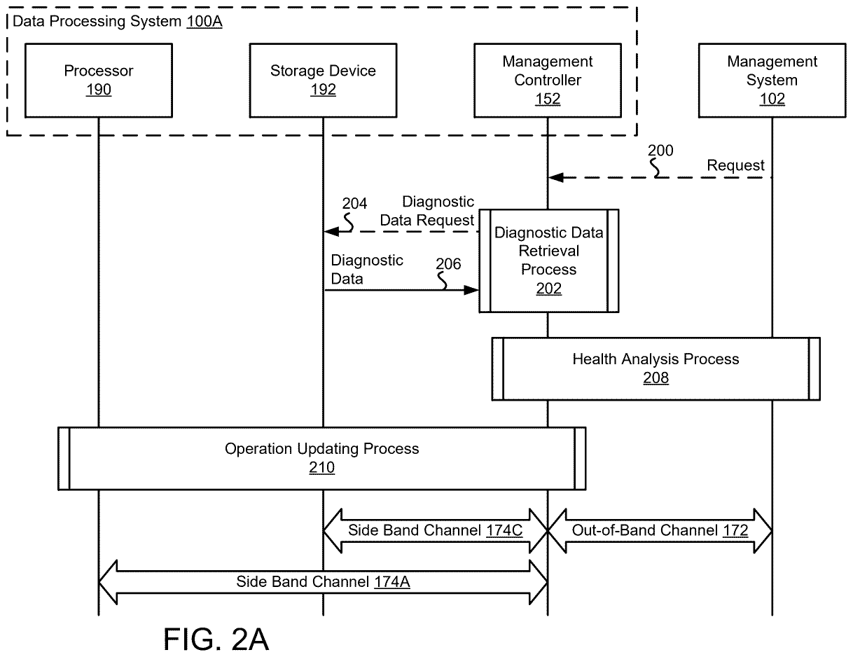

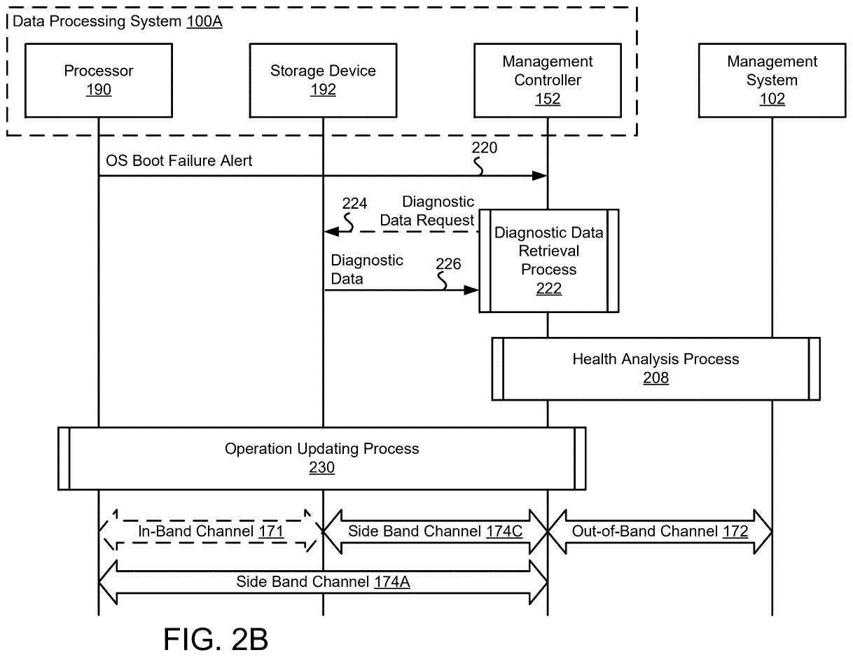

For example, the management controller may obtain diagnostic data from a storage device of data processing system 100A. The management controller may initiate performance of a health analysis process for the storage device, which may include providing the diagnostic data to management system 102. The management controller may receive a response from management system 102 indicating that the level of health for the storage device meets criteria indicating that the storage device is likely to suffer from undesired operation. Based on the level of health meeting the criteria, the management controller may obtain an action set, and the action set may include moving data stored on the storage device to another storage device of data processing system 100A. The management controller may then perform the action set. Refer to the description of FIGS. 2A-2B for additional details regarding performing the health analysis process.

Management system 102 may, as discussed above, provide remote management services for data processing systems 100. Management system 102 may include any number and/or type of devices (e.g., data processing systems) used to interact with data processing systems 100 to obtain and/or provide information (e.g., data) relevant to operation of data processing systems 100. For example, management system 102 may obtain diagnostic data from data processing system 100A and provide levels of health for hardware resources of data processing system 100A to the management controller and/or indications regarding whether the levels of health meet criteria.

Management system 102 may be implemented with multiple computing devices. The computing devices of management system 102 may cooperatively perform processes for managing health of hardware resources of data processing systems 100. The computing devices of management system 102 may perform similar and/or different functions, and may be used by different users (e.g., persons) that may participate in the management of data processing systems 100.

Management system 102 may be maintained, for example, by a business or other entity that has some degree of responsibility with respect to managing the operation of data processing systems 100. For example, management system 102 may be operated by a manufacturer of data processing systems 100 and/or a manufacturer of a portion of hardware resources of data processing systems 100.

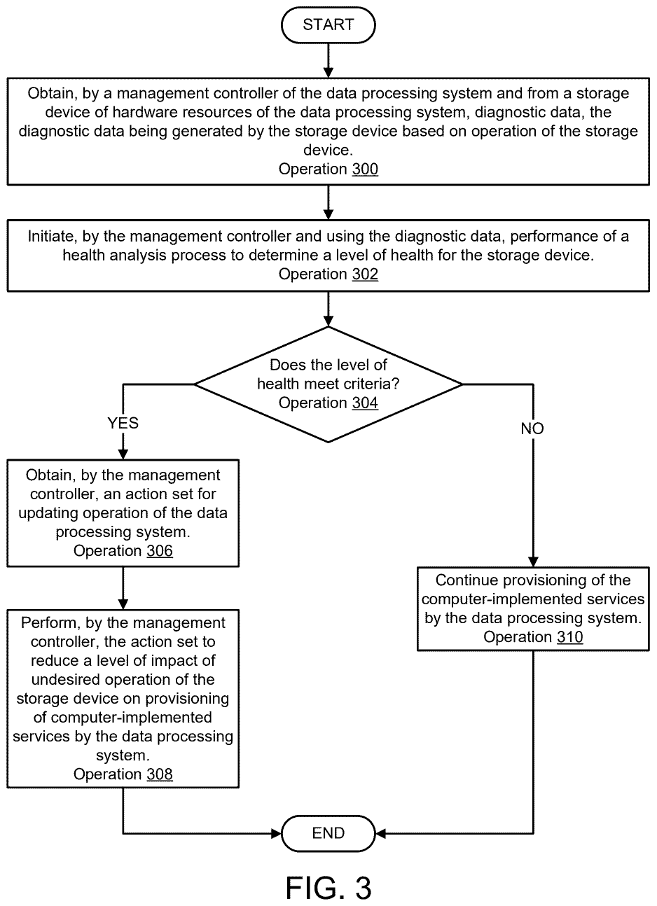

When providing their functionality, any of data processing systems 100 and/or management system 102 may perform all, or a portion of the actions and methods illustrated in FIGS. 2A-3.

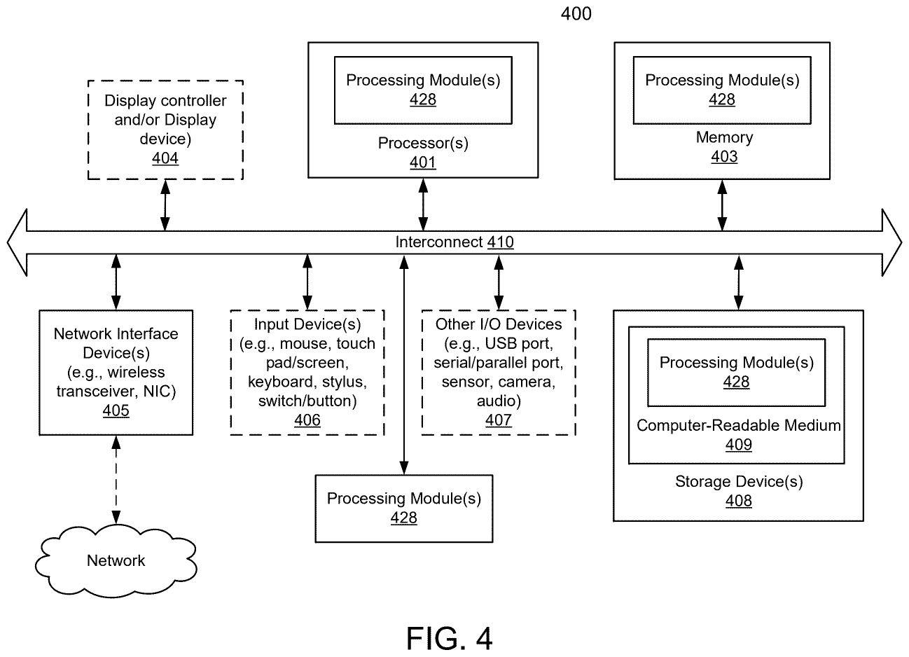

Any of data processing system 100 (and/or components thereof) and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 104. Communication system 104 may facilitate communications between the components of FIG. 1A. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

Thus, as shown in FIG. 1A, a system in accordance with an embodiment may manage operation of a data processing system by using diagnostic data obtained by a management controller of the data processing system from hardware resources of the data processing system (e.g., a storage device). The diagnostic data may be used to perform health analysis processes for the hardware resources (e.g., initiated by the management controller of the data processing system). By doing so, an impact of undesired operation of the hardware resources on the provisioning of computer-implemented services by the data processing system may be reduced.

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 100A shown in FIG. 1B may be similar to any of data processing systems 100 shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express) that may facilitate use of storage resources of the storage device.

For example, the storage may include a first storage device adapted to host an image of a startup management entity (e.g., a basic input/output system (BIOS)), system configurations, and/or any other information. Additionally, the storage may include a second storage device that may include, but not be limited to, storage for information necessary to boot the data processing system, load an operating system for the data processing system, and/or perform any other processes (e.g., boot data).

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A).

Management controller 152 may provide various management functionalities for data processing system 100A. For example, management controller 152 may monitor various ongoing processes performed by the in-band components, may manage power distribution, may provide thermal management services, and/or may perform other functions of data processing system 100A.

To do so, management controller 152 may be operably connected to various components via side band channels 174 (in FIG. 1B, a limited number of side band channels are included for illustrative purposes, it will be appreciated that management controller 152 may communicate with other components via any number of sideband channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry and/or other types of diagnostic data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any of management controller 152, entities hosted by management controller 152, and/or data managed by management controller 152.

For example, management controller 152 may participate in managing health of hardware resources 150. To do so, management controller 152 may obtain diagnostic data from a hardware component of hardware resources 150 (e.g., a storage device) via side band channels 174. Management controller 152 may participate in performance of a health analysis process for the hardware component by providing the diagnostic data to and receiving information from a remote system (e.g., management system 102, refer to FIG. 1A) via an out-of-band channel.

To facilitate communication with other devices, such as the remote system, data processing system 100A may include network module 160. Network module 160 may provide communication services for in-band components and out-of-band components (e.g., management controller 152) of data processing system 100A. To do so, network module 160 may include traffic manager 162 and interfaces 164.

Traffic manager 162 may include functionality to: (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately power domains, different subsets of these components may remain powered while other subsets are unpowered.

For example, management controller 152 and network module 160 may remain powered while hardware resources 150 is unpowered. Consequently, management controller 152 may remain able to communicate with other devices (e.g., the remote system) while hardware resources 150 are inactive. Similarly, management controller 152 may perform various actions while hardware resources 150 are not powered and/or are otherwise inoperable, unable to cooperatively perform various process, are compromised, and/or are unavailable for other reasons. For example, management controller 152 may selectively power a hardware component of hardware resources 150 while the other hardware resources remain unpowered. Doing so may allow management controller 152 to collect data (e.g., diagnostic data) from the hardware component.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3.

While illustrated in FIG. 1B with a limited number of specific components, a system may include additional, fewer, and/or different components without departing from embodiments disclosed herein.

Turning to FIG. 1C, to provide computer-implemented services by a data processing system (e.g., 100A), hardware resources 150 may host processor 190, boot storage device 191, storage device 192, and hardware components 195. Hardware components 195 may include any hardware resources of the data processing system, such as processors, memory modules, storage devices, and/or other types of hardware components usable to provide computer-implemented services.

To provide the computer-implemented services, the data processing system may undergo a booting process (e.g., a startup) to be placed in a desired operating state. During the booting process, hardware resources of the data processing system may be initialized to facilitate operation of an operating system (and/or other management entity of data processing system 100A). To do so, processor 190 may execute instructions indicated by boot data (e.g., firmware, system configurations, etc.). The boot data may be hosted by boot storage device 191 and/or storage device 192.

Boot storage device 191 may include, for example, non-volatile flash memory (e.g., serial peripheral interface (SPI) flash) that may be hosted on a motherboard and adapted to store information, such as firmware, an image of a management entity (e.g., BIOS, universal extensible firmware interface (UEFI), etc.), system configuration files, and/or any other boot data usable to perform startups for data processing system 100A. Because boot storage device 191 may have a limited storage capacity, storage device 192 may be used to store additional information (e.g., other boot data, copies of boot data).

Storage device 192 may include, for example, a second storage device such as a non-volatile memory express (NVMe) solid-state drive. Storage device 192 may include a boot partition (e.g., 193) that may be a portion of storage resources of storage device 192 allocated for storage of boot data (e.g., a latest stable copy of the boot data, bootloader files, configuration files, etc.). Boot partition 193 may, for example, be isolated from other memory sections of storage device 192.

While described with respect to boot partition 193 storing boot data, it will be appreciated that any other type of data may be stored in boot partition 193 without departing from embodiments disclosed herein.

Management controller 152 may operate independently from and may be distinct from hardware resources 150. To communicate with hardware resources 150 and implement management functionalities, management controller 152 may utilize side band channels (e.g., 174A-174C). For example, management controller 152 may communicate with storage device 192 via side band channel 174C. For additional details regarding management controller 152 and side band channels of the data processing system, refer to the description of FIG. 1B.

To execute instructions indicated by the boot data, hardware resources 150 may include processor 190. Processor 190 may include a central processing unit (CPU) and/or any other type of processor that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

Processor 190 may host any number and/or type of entities, which may include an operating system, drivers, applications, and/or any other type of software program that may provide computer-implemented services. As part of performing their functionality, the entities may perform operations with respect to at least a portion of hardware resources 150. For example, the operating system may participate in managing health of storage device 192 by obtaining diagnostic data from storage device 192 via in-band channels 171. However, if the operating system is not and/or is unable to be booted (e.g., due to the data processing system being powered off, due to undesired operation of boot storage device 191 and/or storage device 192 impacting an ability of the operating system to be booted), the operating system may be unable to perform tasks related to managing the health of storage device 192. As a result, management controller 152 may perform tasks to manage the health of storage device 192. For example, management controller 152 may obtain the diagnostic data from storage device 192 via side band channel 174C. Refer to the description of FIG. 2B for additional details regarding managing health of storage device 192 when the operating system is unable to be booted.

To further clarify embodiments disclosed herein, interaction diagrams in accordance with an embodiment are shown in FIGS. 2A-2B. The interaction diagrams may illustrate an example of how data may be obtained and used within the systems of FIGS. 1A-1C. In the examples shown in FIGS. 2A-2B, a data processing system (e.g., 100A) may include components such as hardware resources 150 and management controller 152. Hardware resources 150 may include processor 190 and storage device 192. The components of the data processing system may be similar to and/or include functionality similar to those described with respect to FIGS. 1A-1C.

In the interaction diagrams, processes performed by and interactions between components of a system in accordance with an embodiment are shown. In the diagrams, components of the system are illustrated using a first set of shapes (e.g., 152, 190, etc.), located towards the top of each figure. Lines descend from these shapes. Processes performed by the components of the system are illustrated using a second set of shapes (e.g., 202, 208, etc.) superimposed over these lines. Interactions (e.g., communication, data transmissions, etc.) between the components of the system are illustrated using a third set of shapes (e.g., 200, 206, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur. Lines shown in dashing may indicate that the interactions may or may not occur.

Generally, the processes and interactions are temporally ordered in an example order, with time increasing from the top to the bottom of each page. For example, the interaction labeled as 200 may occur prior to the interaction labeled as 204. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur to reduce a level of impact of undesired operation of a storage device of a data processing system (e.g., 100A, similar to data processing systems described in FIGS. 1A-1C) on provisioning of computer-implemented services by the data processing system.

To reduce the level of impact, management controller 152 may perform diagnostic data retrieval process 202. For example, management controller 152 may perform diagnostic data retrieval process 202 after receiving a request from management system 102 at interaction 200. The request may include: (i) instructions for management controller 152 to provide diagnostic data for at least a portion of the hardware resources of data processing system 100A to management system 102, (ii) information regarding an operation state of at least a portion of the hardware resources, and/or (iii) a request for other information. For example, management system 102 may provide a request for diagnostic data for a storage device of the data processing system (e.g., storage device 192) to management controller 152 at interaction 200.

Management system 102 may provide the request to management controller 152 at interaction 200 by (i) transmission via a message, (ii) storing in a storage with subsequent retrieval by management controller 152, (iii) a publish-subscribe system where management controller 152 subscribes to updates from management system 102 thereby causing a copy of the request to be propagated to management controller 152, and/or (iv) other processes. The request may be provided, for example, via out-of-band channel 172.

Management controller 152 may perform diagnostic data retrieval process 202: (i) in response to obtaining request 200, (ii) based on a schedule, (iii) in response to a trigger, such as an alert from processor 190 (refer to FIG. 2B for additional details), and/or (iv) based on other conditions. For example, management controller 152 may perform diagnostic data retrieval process 202 upon completion of a startup of data processing system 100A. In this example, diagnostic data retrieval process may be performed without obtaining a request from management system 102.

During diagnostic data retrieval process 202, management controller 152 may obtain diagnostic data from storage device 192 (and/or from any other hardware component for which management controller 152 is to provide health management services). The diagnostic data may be generated by storage device 192 based on operation of storage device 192. For example, the diagnostic data may include: (i) SMART data, (ii) telemetry data, (iii) health data, and/or (iv) other types of data usable to determine a level of health for storage device 192. The SMART data included as part of the diagnostic data may include: (i) read error rate, (ii) seek error rate and/or seek time performance, (iii) power-on hours, (iv) temperature data, (v) device power cycle count, and/or (vi) other data based on the operation of storage device 192.

To obtain the diagnostic data, management controller 152 may provide a diagnostic data request to storage device 192 at interaction 204. The diagnostic data request may include: (i) instructions for storage device 192 to provide the diagnostic data to management controller 152, and/or (ii) a request for other information from storage device 192.

Management controller 152 may provide the diagnostic data request to storage device 192 at interaction 204 by (i) transmission via a message, (ii) storing in a storage with subsequent retrieval by storage device 192, (iii) a publish-subscribe system where storage device 192 subscribes to updates from management controller 152 thereby causing a copy of the diagnostic data request to be propagated to storage device 192, and/or (iv) other processes. The diagnostic data request may be provided, for example, via side band channel 174C.

Management controller 152 may provide the request for the diagnostic data to storage device 192 when the hardware resources of the data processing system are powered or unpowered. For example, management system 102 may provide a request to management controller 152 for the diagnostic data for storage device 192 when the hardware resources, including storage device 192, are powered off. Management controller 152 and the hardware resources may be positioned in separately controllable power domains, and thus, management controller 152 may be able to obtain the request from management system 102 while the hardware resources are powered off. In response to the request, management controller 152 may cooperate with a power manager of the data processing system to selectively power storage device 192 while other hardware resources of the data processing system remain unpowered. In doing so, management controller 152 may request and obtain the diagnostic data from storage device 192 in instances when the hardware resources are unpowered.

Storage device 192 may read the request for the diagnostic data from management controller 152 and obtain a response to the request, the response including the diagnostic data. Storage device 192 may provide the diagnostic data to management controller 152 at interaction 206 by (i) transmission via a message, (ii) storing in a storage with subsequent retrieval by management controller 152, (iii) a publish-subscribe system where management controller 152 subscribes to updates from storage device 192 thereby causing a copy of the diagnostic data to be propagated to management controller 152, and/or (iv) other processes. The diagnostic data may be provided, for example, via side band channel 174C.

While described with respect to management controller 152 providing a request for the diagnostic data to storage device 192 and obtaining the diagnostic data in response, it will be appreciated that the diagnostic data may be provided to management controller 152 without management controller 152 providing the request. For example, storage device 192 may provide the diagnostic data: (i) based on a schedule, (ii) in response to a trigger (e.g., an error, a loss of power, and/or other triggers), and/or (iii) based on other conditions.

Upon obtaining the diagnostic data from storage device 192, management controller 152 may perform health analysis process 208 cooperatively with management system 102 to determine a level of health for storage device 192. The level of health may include an indication regarding a health status, state, and/or condition of storage device 192. The level of health may represent the health status for storage device 192 by accounting for various values included in the diagnostic data in aggregate. For example, the level of health may include: (i) a designation such as good, fair, poor, critical, etc., (ii) a numerical score corresponding to the health and/or performance of storage device 192 (e.g., based on any scale for assigning numerical levels of health), and/or (iii) other indications of levels of health.

During health analysis process 208, management controller 152 may initiate performance of a health analysis process by providing the diagnostic data to management system 102 via out-of-band channel 172. Management controller 152 may provide the diagnostic data to management system 102 by (i) transmission via a message, (ii) storing in a storage with subsequent retrieval by management system 102, (iii) a publish-subscribe system where management system 102 subscribes to updates from management controller 152 thereby causing a copy of the diagnostic data to be propagated to management system 102, and/or (iv) other processes.

Management controller 152 may receive a response via out-of-band channel 172 from management system 102 following provision of the diagnostic data to management system 102. The response may include: (i) the level of health for storage device 192, (ii) an indication regarding whether the level of health for storage device 192 meets criteria (e.g., a “yes” or “no” indication, a difference between threshold values included in the criteria and values obtained as part of the diagnostic data), (iii) instructions for management controller 152 to perform an action set based on the level of health, and/or (iv) other information.

The criteria may include a threshold level of health for storage device 192, and meeting the threshold level of health (e.g., based on any definition of meeting the threshold, such as being greater than the threshold, being greater than or equal to the threshold, etc.) may indicate that storage device 192 has an unacceptable risk of suffering from undesired operation (e.g., at a future point in time). The undesired operation may include: (i) failure of storage device 192, (ii) loss of data stored on storage device 192, (iii) overheating of storage device 192 (e.g. resulting in physical damage to storage device 192 and/or other hardware resources of the data processing system), and/or (iv) other undesired operations.

For example, the level of health may be assigned on a scale of 1-10, where 1 indicates storage device 192 has a low risk of suffering from the undesired operation, and 10 indicates storage device 192 has a high risk of suffering from the undesired operation. The threshold level of health may be set to 6. If the level of health for storage device 192 is determined to be 4, the level of health may not meet the criteria, and storage device 192 may have an acceptable risk of suffering from the undesired operation. If the level of health of storage device 192 is determined to be 8, the level of health may meet the criteria, and storage device 192 may have an unacceptable risk of suffering from the undesired operation.

The threshold values indicative of the unacceptable risk may be determined by: (i) a user of the data processing system, (ii) a manufacturer of storage device 192 and/or data processing system 100A, and/or (iii) other entities.

During health analysis process 208, management controller 152 may also initiate performance of the health analysis process by determining the level of health for storage device 192 (e.g., without providing the diagnostic data to management system 102). For example, management controller may perform any number and/or type of analysis processes to assign the level of health to storage device 192. Management controller 152 may compare the level of health to the criteria (e.g., obtained from management system 102 and/or any other entity) to determine whether the level of health meets the criteria.

In a first example, management controller 152 may obtain SMART data (e.g., diagnostic data) from a non-volatile memory express (NVMe) device (e.g., storage device 192). Management controller 152 may provide the SMART data to management system 102, and may receive a response from management system 102 indicating that the level of health for the NVMe device meets criteria.

In a second example, management controller 152 may obtain the SMART data from the NVMe device and may provide the SMART data to management system 102. Management controller 152 may receive the level of health for the NVMe device in response from management system 102. Using the level of health and the criteria, management controller 152 may determine whether the level of health meets the criteria.

In a third example, management controller 152 may obtain the SMART data from the NVMe device. Management controller 152 may analyze the SMART data to determine the level of health for the NVMe device. Based on the level of health and using the criteria (e.g., obtained from management system 102, obtained from a user of the data processing system), management controller 152 may determine whether the level of health meets the criteria.

If a result of health analysis process 208 indicates that the level of health meets the criteria, operation updating process 210 may be performed. During operation updating process 210, management controller 152 may obtain an action set for updating operation of data processing system 100A. Obtaining the action set may include: (i) receiving the action set from management system 102, (ii) generating the action set by management controller 152 based on the level of health and a rule set, policy, and/or other type of schema for obtaining action sets based on levels of health (e.g., obtained from management system 102, obtained from the user of data processing system 100A), and/or other methods.

The action set may include: (i) notifying the user of data processing system 100A to the level of health for storage device 192 and/or other information obtained as part of the diagnostic data(e.g., generating an auditory notification, displaying a visual notification on a graphical user interface), (ii) modifying use of storage device 192 (e.g., preventing new data from being stored on storage device 192, reducing power supply to storage device 192), (iii) moving data stored on storage device 192 to a second storage device of the data processing system (e.g., obtaining a copy of the data and storing the copy of the data on the second storage device), (iv) providing a copy of the data stored on storage device 192 to management system 102 and/or another entity, and/or (v) other actions.

The action set may be performed by management controller 152 to reduce a level of impact of undesired operation of storage device 192 on provisioning of computer-implemented services by data processing system 100A. To perform the action set, management controller 152 may provide instructions to processor 190 via side band channel 174A. For example, management controller 152 may instruct processor 190 to store data on other storage devices of the data processing system rather than storage device 192.

For example, the undesired operation of storage device 192 may result in loss of boot data stored on storage device 192. Consequently, data processing system 100A may be unable to boot and thus, may be unable to provide the computer-implemented services. The action set may include moving the boot data stored on storage device 192 to a second storage device. Management controller 152 may instruct processor 190 to obtain the boot data from the second storage device while performing subsequent booting processes. As a result of performing the action set, an impact of the undesired operation of storage device 192 on the provisioning of the computer-implemented services may be reduced, as the boot data may be retrieved from the second storage device during booting processes and data processing system 100A may boot as desired.

Turning to FIG. 2B, a second interaction diagram in accordance with an embodiment is shown. The second interaction diagram may illustrate processes and interactions that may occur to reduce a level of impact of undesired operation of a storage device (e.g., storage device 192) of a data processing system (e.g., 100A, similar to data processing systems described in FIGS. 1A-1C) on provisioning of computer-implemented services by data processing system 100A in an instance when an operating system of data processing system 100A is unable to be booted.

In order to reduce the level of impact of the undesired operation of storage device 192 on provisioning of the computer-implemented services by data processing system 100A, processor 190 (e.g., a CPU and/or other type of processor of data processing system 100A, refer to the description of FIG. 1C) may be adapted to obtain diagnostic data from storage device 192 via an in-band channel of data processing system 100A (e.g., in-band channel 171) when an operating system (and/or other management entity) of data processing system 100A is booted. By doing so, processor 190 may perform actions to reduce a likelihood of failure of storage device 192 and/or mitigate an impact of failure of storage device 192 on provisioning of the computer-implemented services. Refer to the description of FIG. 2A for additional details regarding performing the actions based on the diagnostic data.

Consider a scenario in which a booting process for data processing system 100A is being performed to place data processing system 100A in a desired operating state to provide the computer-implemented services. To do so, processor 190 may utilize boot data (e.g., basic input/output system (BIOS) firmware, system configuration files, etc.) that may be stored on a boot storage device (e.g., not shown, similar to boot storage device 192, refer to FIG. 1C). The boot storage device may include, for example, a non-volatile memory storage device (e.g., serial peripheral interface flash).

However, processor 190 may be unable to perform the booting process using the boot data stored on the boot storage device. For example, processor 190 may be unable to perform the booting process when at least one copy of the boot data hosted by the boot storage device includes erroneous data (e.g., corrupted firmware, malicious data, incompatible firmware version, etc.), a firmware image is improperly flashed on the boot storage device, and/or any other causes impacting an ability of processor 190 to perform the booting process. As a result, processor 190 may be unable to boot an operating system (and/or other management entity of the data processing system).

If processor 190 is unable to perform the booting process using the boot data stored on the boot storage device, processor 190 may obtain the boot data from storage device 192. Storage device 192 may be used to redundantly store the boot data usable to boot the operating system (e.g., a copy of the boot data may be stored on storage device 192 for use in instances when the boot data is unable to be obtained from the boot storage device). However, processor 190 may be unable to obtain the boot data from storage device 192 (e.g., due to undesired operation of storage device 192, due to in-band communication channels being unavailable). Consequently, the operating system may be unable to be booted.

Management controller 152, as discussed, may operate independently from the hardware resources and may be distinct from and adapted to manage the hardware resources. For example, management controller 152 may operate during the booting process and/or regardless of an outcome of the booting process performed by booting components (e.g., the boot storage device, processor 190, storage device 192) of the hardware resources.

Management controller 152 may monitor a boot status of data processing system 100A by obtaining information regarding the booting process from processor 190 using a side band communication channel (e.g., side band channel 174A). In an instance when the booting process is unsuccessful (e.g., processor 190 is unable to boot the operating system), processor 190 may provide an operating system (OS) boot failure alert to management controller 152. The OS boot failure alert may include: (i) an indication that the operating system was unable to be booted, (ii) information regarding the booting process failure, and/or (iii) other information.

The OS boot failure alert may be provided to management controller 152 at interaction 220 by (i) transmission via a message, (ii) storing in a storage with subsequent retrieval by management controller 152, (iii) a publish-subscribe system where management controller 152 subscribes to updates from processor 190 thereby causing a copy of the OS boot failure alert to be propagated to management controller 152, and/or (iv) other processes. The alert may be provided, for example, via side band channel 174A.

Management controller 152 may be adapted to obtain diagnostic data from storage device 192 via a side band channel (e.g., side band channel 174C) when the operating system is unable to be booted. Upon identifying that the operating system is unable to be booted due to, at least in part, an inability of processor 190 to obtain the boot data from storage device 192, management controller 152 may obtain diagnostic data from storage device 192.

To obtain the diagnostic data, management controller 152 may perform diagnostic data retrieval process 222. During diagnostic data retrieval process 222, management controller 152 may provide a diagnostic data request to storage device 192 at interaction 224. The diagnostic data request may include: (i) instructions for storage device 192 to provide the diagnostic data to management controller 152, and/or (ii) a request for other information from storage device 192.

Management controller 152 may provide the diagnostic data request to storage device 192 at interaction 224 by (i) transmission via a message, (ii) storing in a storage with subsequent retrieval by storage device 192, (iii) a publish-subscribe system where storage device 192 subscribes to updates from management controller 152 thereby causing a copy of the diagnostic data request to be propagated to storage device 192, and/or (iv) other processes. The diagnostic data request may be provided, for example, via side band channel 174C.

Storage device 192 may read the request for the diagnostic data from management controller 152 and obtain a response to the request, the response including the diagnostic data. Storage device 192 may provide the diagnostic data to management controller 152 at interaction 226 by (i) transmission via a message, (ii) storing in a storage with subsequent retrieval by management controller 152, (iii) a publish-subscribe system where management controller 152 subscribes to updates from storage device 192 thereby causing a copy of the diagnostic data to be propagated to management controller 152, and/or (iv) other processes. The diagnostic data may be provided, for example, via side band channel 174C.

While described with respect to management controller 152 providing a request for the diagnostic data to storage device 192 and obtaining the diagnostic data in response, it will be appreciated that the diagnostic data may be provided to management controller 152 without management controller 152 providing the request. For example, storage device 192 may provide the diagnostic data: (i) based on a schedule, (ii) in response to a trigger (e.g., an error, a loss of power, and/or other triggers), and/or (iii) based on other conditions.

Upon obtaining the diagnostic data from storage device 192, management controller 152 may perform health analysis process 208 cooperatively with management system 102 to determine a level of health for storage device 192. Refer to the description of FIG. 2A for additional details regarding health analysis process 208.

If a result of health analysis process 208 indicates that the level of health meets the criteria, operation updating process 230 may be performed. During operation updating process 230, management controller 152 may obtain and perform an action set for updating operation of data processing system 100A. Refer to the description of FIG. 2A for additional details regarding obtaining and performing the action set.

For example, as a part of performing operation updating process 230, management controller 152 may move the boot data from storage device 192 to a second storage device of data processing system 100A. Management controller 152 may subsequently initiate a rebooting process. During the rebooting process, processor 190 may use the boot data from the second storage device to boot the operating system and place data processing system 100A in the desired operating state.

Thus, the processes and interactions shown in FIGS. 2A-2B may be used to obtain diagnostic data by a management controller of a data processing system from a storage device of the data processing system. The diagnostic data may be used to perform a health analysis process to determine a level of health for the storage device. If the level of health meets criteria, the management controller may obtain and perform an action set to reduce a level of impact of undesired operation of the storage device on provisioning of computer-implemented services by the data processing system.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2B may perform various methods to manage the operation of data processing systems. FIG. 3 illustrates a method that may be performed by the components of the system of FIGS. 1A-2B. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system, any component of a data processing system (e.g., a management controller, hardware resources) and/or another device.

Turning to FIG. 3, a flow diagram illustrating a method in accordance with an embodiment is shown. The flow diagram may illustrate various operations performed while managing operation of a data processing system. The data processing system may include hardware resources and a management controller, and may be similar to the data processing system discussed with respect to FIGS. 1A-1C.

At operation 300, a management controller of the data processing system may obtain, from a storage device of hardware resources of the data processing system, diagnostic data, the diagnostic data being generated by the storage device based on operation of the storage device. Obtaining the diagnostic data may include: (i) receiving the diagnostic data via a message from the storage device (e.g., via a side band channel of the data processing system), (ii) reading the diagnostic data from storage, (iii) receiving the diagnostic data via a publish-subscribe system (e.g., by subscribing to updates from the storage device), (iv) selectively powering the storage device by the management controller while other hardware resources of the hardware resources of the data processing system remain unpowered, and/or (v) other methods.

Selectively powering the storage device by the management controller may include: (i) providing instructions, by the management controller, to a power manager of the data processing system, the instructions indicating that the storage device is to be powered, (ii) while the storage device is in a powered state, collecting, by the management controller, the diagnostic data from the storage device (e.g., providing, by the management controller, a request for the diagnostic data to the storage device, receiving, by the management controller, the diagnostic data in response to the request), and/or (iii) other methods.

At operation 302, the management controller may initiate performance of a health analysis process using the diagnostic data to determine a level of health for the storage device. Initiating performance of the health analysis process may include: (i) providing, by the management controller and via an out-of-band communication channel, the diagnostic data to a remote system, (ii) receiving, by the management controller and via the out-of-band communication channel, an indication regarding whether the level of health meets the criteria in response to the providing, (iii) receiving, by the management controller and via the out-of-band communication channel, the level of health for the storage device, (iv) analyzing, by the management controller and via any type and quantity of analysis methods, the diagnostic data to determine the level of health, and/or (v) other methods.

Providing the diagnostic data to the remote system may include: (i) transmitting the diagnostic data to the remote system via a message, (ii) storing the diagnostic data in storage with subsequent retrieval by the remote system, (iii) providing the diagnostic data to another entity responsible for providing the diagnostic data to the remote system, and/or (iv) other methods.

Receiving the indication regarding whether the level of health meets the criteria may include: (i) obtaining the indication via a message from the remote system, (ii) obtaining the indication via a message from another entity, (iii) reading the indication from a storage used by the remote system, and/or (iv) other methods.

At operation 304, it may be determined whether the level of health meets criteria. Determining whether the level of health meets the criteria may include: (i) reading the response obtained from the remote system indicating whether the level of health meets the criteria, (ii) obtaining, by the management controller, the criteria (e.g., via a message from the remote system and/or any other entity, reading the criteria from storage, via input from a user of the data processing system), (iii) comparing the level of health to the criteria to determine whether the level of health meets the criteria (e.g., comparing a value and/or other information from the level of health to a threshold included in the criteria to determine whether the level of health meets the threshold and thus, meets the criteria), and/or (iv) other methods.

If it is determined that the level of health meets the criteria (e.g., the determination is “Yes” at operation 304), then the method may proceed to operation 306.

At operation 306, the management controller may obtain an action set for updating operation of the data processing system. Obtaining the action set may include: (i) receiving the action set from another device (e.g., the remote system), (ii) reading the action set from storage, (iii) dynamically generating the action set based on any number of factors (e.g., based on a policy, rule set, and/or other type of schema for generating action sets), and/or (iv) other methods.

At operation 308, the management controller may perform the action set to reduce a level of impact of undesired operation of the storage device on provisioning of computer-implemented services by the data processing system. Performing the action set may include: (i) notifying a user of the data processing system to the level of health for the storage device (e.g., generating an auditory notification by powering a speaker, displaying a visual notification on a graphical user interface), (ii) modifying use of the storage device (e.g., instructing a processor to store data on a different storage device of the data processing system, instructing a power manager of the data processing system to reduce power to the storage device, discontinuing use of the storage device), (iii) moving data stored on the storage device to a second storage device of the data processing system (e.g., obtaining a copy of the data stored on the storage device, storing the copy of the data on the second storage device), (iv) providing a copy of the data stored on the storage device to the remote system (e.g., obtaining the copy of the data stored on the storage device, transmitting the copy of the data to the remote system), and/or (v) other methods.

The method may end following operation 308.

Returning to operation 304, if it is determined that the level of health does not meet the criteria (e.g., the determination is “No” at operation 304), then the method may proceed to operation 310.

At operation 310, provisioning of the computer-implemented services by the data processing system may continue. Continuing to provision the computer-implemented services may include continuing normal use of the storage device.

The method may end following operation 310.

Thus, as illustrated above, embodiments disclosed herein may provide systems and methods usable to manage operation of a data processing system using a management controller of the data processing system. The management controller may obtain diagnostic data from hardware resources of the data processing system, such as a storage device, the diagnostic data being usable to provide health management services for the hardware resources. By using the management controller to obtain the diagnostic data, health of the hardware resources may be managed even in instances when in-band methods are unavailable (e.g., when the operating system is unable to be booted and/or the hardware resources are unpowered). As a result, an impact of undesired operation of the hardware resources may be reduced, and the data processing system may provide computer-implemented services as desired.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a data processing system, the method comprising:
obtaining, by a management controller of the data processing system and from a storage device the data processing system, diagnostic data, wherein the diagnostic data is generated by the storage device based on operation of the storage device, the storage device is part of hardware resources of the data processing system, the diagnostic data is obtained by the management controller when an operating system of the data processing system is unable to be booted, a processor of the hardware resources of the data processing system is adapted to obtain the diagnostic data from the storage device via an in-band channel of the data processing system when the operating system is booted, the management controller is adapted to obtain the diagnostic data from the storage device via a side band channel when the operating system is unable to be booted, boot data usable to boot the operating system is redundantly stored on the storage device, and the operating system is unable to be booted due to the processor being unable to obtain the boot data from the storage device;
initiating, by the management controller and using the diagnostic data, performance of a health analysis process to determine a level of health for the storage device;
in an instance of the initiating in which the level of health meets a criterion:
obtaining, by the management controller, an action set for updating operation of the data processing system; and
performing, by the management controller, the action set to reduce a level of impact of undesired operation of the storage device on provisioning of computer-implemented services by the data processing system.

2. The method of claim 1, wherein initiating performance of the health analysis process comprises:
providing, by the management controller and via an out-of-band communication channel, the diagnostic data to a remote system; and
receiving, by the management controller and via the out-of-band communication channel, an indication regarding whether the level of health meets the criterion in response to the providing.

3. The method of claim 1, wherein obtaining the diagnostic data comprises:
selectively powering the storage device by the management controller while other hardware resources of the hardware resources of the data processing system remain unpowered.

4. (canceled)

5. (canceled)

6. (canceled)

7. The method of claim 1, wherein the criterion comprises a threshold level of health for the storage device, and meeting the threshold level of health indicates that the storage device has an unacceptable risk of suffering from the undesired operation.

8. The method of claim 1, wherein the action set comprises at least one action selected from a list of actions consisting of:
notifying a user of the data processing system to the level of health for the storage device;
modifying use of the storage device;
moving data stored on the storage device to a second storage device of the data processing system; and
providing a copy of the data stored on the storage device to a remote system.

9. The method of claim 1, wherein the diagnostic data is self-monitoring, analysis and reporting technology (SMART) data.

10. The method of claim 1, wherein the management controller operates independently from and is distinct from the hardware resources.

11. The method of claim 1, wherein the diagnostic data is obtained by the management controller via a side band channel of the data processing system.

12. A non-transitory machine-readable medium having instructions stored therein, which when executed by a processor, cause the processor to perform operations for managing operation of a data processing system, the operations comprising:
obtaining, by a management controller of the data processing system and from a storage device the data processing system, diagnostic data, wherein the diagnostic data is generated by the storage device based on operation of the storage device, the storage device is part of hardware resources of the data processing system, the diagnostic data is obtained by the management controller when an operating system of the data processing system is unable to be booted, a processor of the hardware resources of the data processing system is adapted to obtain the diagnostic data from the storage device via an in-band channel of the data processing system when the operating system is booted, the management controller is adapted to obtain the diagnostic data from the storage device via a side band channel when the operating system is unable to be booted, boot data usable to boot the operating system is redundantly stored on the storage device, and the operating system is unable to be booted due to the processor being unable to obtain the boot data from the storage device;
initiating, by the management controller and using the diagnostic data, performance of a health analysis process to determine a level of health for the storage device;
in an instance of the initiating in which the level of health meets a criterion:
obtaining, by the management controller, an action set for updating operation of the data processing system; and
performing, by the management controller, the action set to reduce a level of impact of undesired operation of the storage device on provisioning of computer-implemented services by the data processing system.

13. The non-transitory machine-readable medium of claim 12, wherein initiating performance of the health analysis process comprises:
providing, by the management controller and via an out-of-band communication channel, the diagnostic data to a remote system; and
receiving, by the management controller and via the out-of-band communication channel, an indication regarding whether the level of health meets the criterion in response to the providing.

14. The non-transitory machine-readable medium of claim 12, wherein obtaining the diagnostic data comprises:
selectively powering the storage device by the management controller while other hardware resources of the hardware resources of the data processing system remain unpowered.

15. (canceled)

16. (canceled)

17. A data processing system, comprising:
a processor; and
a memory coupled to the processor to store instructions, which when executed by the processor, cause the processor to perform operations for managing operation of the data processing system, the operations comprising:
obtaining, by a management controller of the data processing system and from a storage device of the data processing system, diagnostic data, wherein the diagnostic data is generated by the storage device based on operation of the storage device, the storage device is part of hardware resources of the data processing system, the diagnostic data is obtained by the management controller when an operating system of the data processing system is unable to be booted, a processor of the hardware resources of the data processing system is adapted to obtain the diagnostic data from the storage device via an in-band channel of the data processing system when the operating system is booted, the management controller is adapted to obtain the diagnostic data from the storage device via a side band channel when the operating system is unable to be booted, boot data usable to boot the operating system is redundantly stored on the storage device, and the operating system is unable to be booted due to the processor being unable to obtain the boot data from the storage device;
initiating, by the management controller and using the diagnostic data, performance of a health analysis process to determine a level of health for the storage device;
in an instance of the initiating in which the level of health meets a criterion:
obtaining, by the management controller, an action set for updating operation of the data processing system; and
performing, by the management controller, the action set to reduce a level of impact of undesired operation of the storage device on provisioning of computer-implemented services by the data processing system.

18. The data processing system of claim 17, wherein initiating performance of the health analysis process comprises:
providing, by the management controller and via an out-of-band communication channel, the diagnostic data to a remote system; and
receiving, by the management controller and via the out-of-band communication channel, an indication regarding whether the level of health meets the criterion in response to the providing.

19. The data processing system of claim 17, wherein obtaining the diagnostic data comprises:
selectively powering the storage device by the management controller while other hardware resources of the hardware resources of the data processing system remain unpowered.

20. (canceled)

21. The non-transitory machine-readable medium of claim 12, wherein the criterion comprises a threshold level of health for the storage device, and meeting the threshold level of health indicates that the storage device has an unacceptable risk of suffering from the undesired operation.

22. The non-transitory machine-readable medium of claim 12, wherein the action set comprises at least one action selected from a list of actions consisting of:
notifying a user of the data processing system to the level of health for the storage device;
modifying use of the storage device;
moving data stored on the storage device to a second storage device of the data processing system; and
providing a copy of the data stored on the storage device to a remote system.

23. The non-transitory machine-readable medium of claim 12, wherein the diagnostic data is self-monitoring, analysis and reporting technology (SMART) data.

24. The non-transitory machine-readable medium of claim 12, wherein the management controller operates independently from and is distinct from the hardware resources.

25. The non-transitory machine-readable medium of claim 12, wherein the diagnostic data is obtained by the management controller via a side band channel of the data processing system.

26. The data processing system of claim 17, wherein the criterion comprises a threshold level of health for the storage device, and meeting the threshold level of health indicates that the storage device has an unacceptable risk of suffering from the undesired operation.
